(19) United States
(12) Patent Application Publication
(10) Pub. No.: US 2017/0341586 A1
(43) Pub. Date: Nov. 30, 2017

(54) VEHICLE-MOUNTED STORAGE BOX

(71) Applicants: Minghua Zhang, KunShan City (CN); Guanwen Wang, Chengdu City (CN)

(72) Inventor: Deming Wang, Beijing (CN)

(21) Appl. No.: 15/163,954

(22) Filed: May 25, 2016

(51) Int. Cl. B60R 5/04; B60R 11/00

(52) U.S. Cl. CPC B60R 5/044; B60R 2011/0094

(57) ABSTRACT

This utility model relates to a vehicle-mounted storage box, which could be a new product in the field of auto parts. The vehicle-mounted storage box includes boxes, which are provided with push-pull drawers. Both sides of the drawer are provided with a sliding mechanism that is used to slide the drawer. The mechanism comprises guide pulley seats, guide pulleys, and a guide track. The guide pulleys are installed on the guide pulley seats and are rotatable. The guide track is located at one side of the drawer. The guide pulley seats are fixed in the box at the positions corresponding to the location of the guide track. The guide pulleys are embedded in the guide track and can roll on the guide track. There is a ringed groove carved at the outer edge of the guide pulley, and there are raised lines on the guide track, which can be set in the ringed groove. The shape of the ringed groove is well matched with that of the raised line. The storage box is provided with push-pull drawers, so that users can use the storage box directly without having to remove the articles on it and lift its top covers, and thus save a lot of time and labor. Meanwhile, the raised line structure at the contact area between the guide track and guide pulleys in the sliding mechanisms on both sides of the drawer enables the drawer to carry relatively heavy objects.

### FIELD OF THE INVENTION

This invention relates to the field of auto parts, and particularly relates to a vehicle-mounted storage box.

### BACKGROUND OF THE INVENTION

Vehicle-mounted storage boxes are installed in the trunk of cars and used for storing articles. People are used to stack articles on the top of the storage boxes to fully use the limited room. However, when they need to take out the articles in the storage boxes, they have to move away the top cover of the storage boxes as well as all the articles stacked on the top. It always consumes a lot of time and labor to do this, because the top cover is big and the articles stacked on the top are many. Therefore, it is necessary to design drawers in vehicle-mounted storage boxes. However, the design sliding mechanism of existing drawers is so defectively designed that the drawers cannot bear relatively high load and thus cannot meet the requirement on loading capacity of vehicle-mounted storage boxes.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

This invention is designed to provide a vehicle-mounted storage box with drawers and high loading capacity, to solve or at least alleviate one or more technical problems in existing vehicle-mounted storage boxes.

The invention provides a vehicle-mounted storage box that comprises boxes; the said boxes are provided with push-pull drawers; both sides of the said drawer are provided with a sliding mechanism that is used to slide the said drawer; the said mechanism comprises guide pulley seats, guide pulleys, and a guide track; the said guide pulleys are installed on the guide pulley seats, and are rotatable; the said guide track is located at one side of the drawer; the said guide pulley seats are fixed in the said box at the positions corresponding to the location of the said guide track; the said guide pulleys are embedded in the said guide track and can roll on the said guide track; there is a ringed groove carved at the outer edge of the said guide pulley, and there are raised lines on the said guide track, which can be set in the said ringed groove; the shape of the said ringed groove is well matched with that of the said raised line.

The cross sections of both the ringed groove and raised line may be half-round.

The vehicle-mounted storage box may include the side plates at the sides of the drawer; the guide pulley seat includes two symmetrically arranged installation parts, which are respectively fixed on both sides of the side plate; the side plate at the position corresponding to the installation parts is well matched with the installation parts in shape.

The vehicle-mounted storage box may include a division plate, which divides the inner space of the storage box into at least two storage spaces; every one of the storage spaces is provided with a said drawer; both sides of the division plate are provided with the said installation parts.

The drawer may be provided with a locking device; the said boxes are provided with fixed blocks; the locking device comprises a rotary drive part and a hook that can be driven by the rotary drive part; when the drawer is closed, the hook and fixed block would be buckled.

The locking device may include a shield, a hinge pin, two helical torsion springs, and a drive link that can be driven by the rotary drive part; the shield is placed above the rotary drive part and used to cover the part; the hinge pin is placed through the rotary drive part, with its two ends out of the rotary drive part; the helical torsion springs are placed at both the ends of the hinge pin by putting them through the hinge pin, with the two ends of each spring extending in two opposite directions normal to the hinge pin, one end pressing against the bottom surface of the shield, and the other end buckling against the bottom surface of the rotary drive part; the drive link is placed through the shield and is rotatable, and then installed on the rotary drive part; the hook is fixed on the drive link.

The vehicle-mounted storage box may include a division plate, which divides the inner space of the storage box into at least two storage spaces; every one of the storage spaces is provided with a said drawer.

Further, the fixed block may be fixed on the division plate.

Compared with existing vehicle-mounted storage boxes, this invention has the following beneficial effects, at least in one or more preferred embodiments. The storage box is provided with push-pull drawers, so that users can use the storage box directly without having to remove the articles on it and lift its top covers, and thus save a lot of time and labor. Meanwhile, the raised line structure at the contact area between the guide track and guide pulleys in the sliding mechanisms on both sides of the drawer, as well as the overall structural design realize tight joint between the guide pulleys and guide track, and no deformation of the guide track when bearing loads, and thus enable the drawer to carry relatively heavy objects. In addition, the sliding mechanism ensures the drawer would slide freely even when carrying high load and produce no excessive clearance. It can also prevent external impurities from entering the storage box, bring high dust, sand, water, and weather resistance, and keep the guide track unblocked.

Further, the rotary drive part may include a clasp part and a drive part that protrudes from the side of the rotary drive part; the locking device further includes drive blocks; one end of the drive block is placed on the drive part by putting it through the drive part, and the other end is fixed on the drive link.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is the diagram showing the space structure of a vehicle-mounted storage box, as an embodiment of the invention, installed in a car trunk.

FIG. 2 is the diagram showing the partial breakdown structure of the vehicle-mounted storage box shown in FIG. 1.

FIG. 3 is the diagram showing the vertical profile of the sliding mechanism of the drawer shown in FIG. 2.

FIG. 4 is the diagram showing the boxes of the vehicle-mounted storage box shown in FIG. 1.

FIG. 5 is the enlarged diagram showing the area A in FIG. 4.

FIG. 6 is the diagram showing the space structure of the drawer in the vehicle-mounted storage box shown in FIG. 1.

FIG. 7 is the diagram showing the breakdown structure of the drawer shown in FIG. 6.

FIG. 8 is the diagram showing the breakdown structure of the locking device in the drawer shown in FIG. 7.

FIG. 9 is the diagram showing the vertical profile of the locking device in the drawer shown in FIG. 7.

### DETAILED DESCRIPTION OF THE EMBODIMENTS

The invention is hereinafter described in detail with reference to an embodiment and the drawings, to better illustrate the technical problem the invention is designed to solve, as well as the technical solution and beneficial effects. It should be understood that the embodiment described hereinafter is illustrative and non-restrictive in every respect.

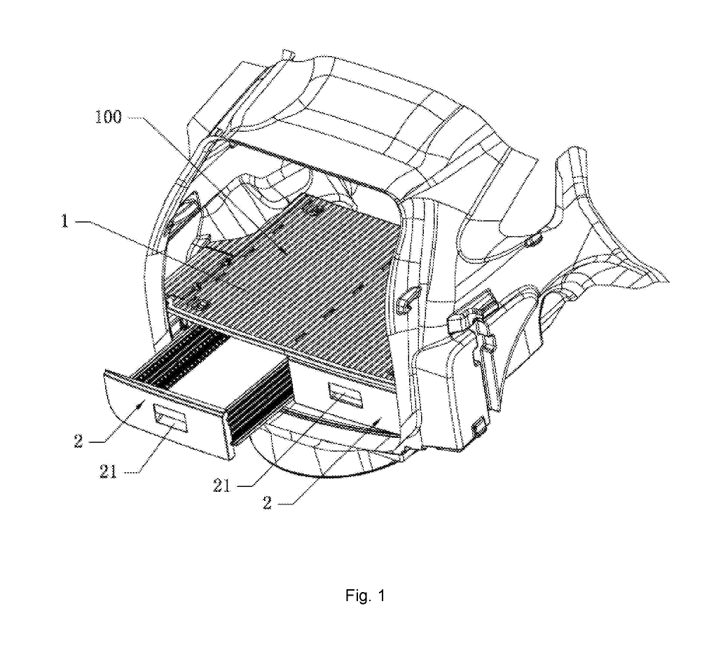

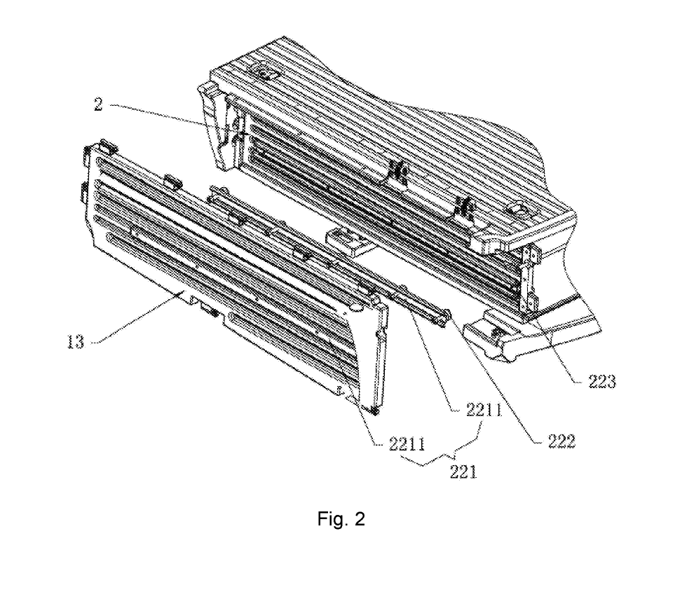

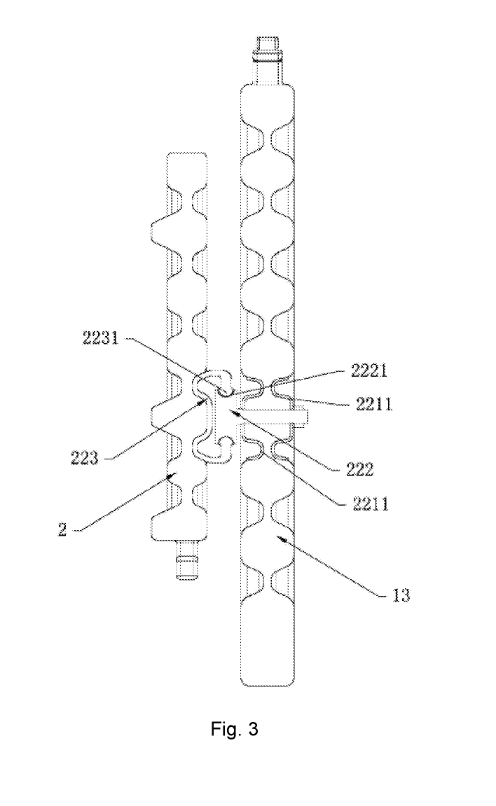

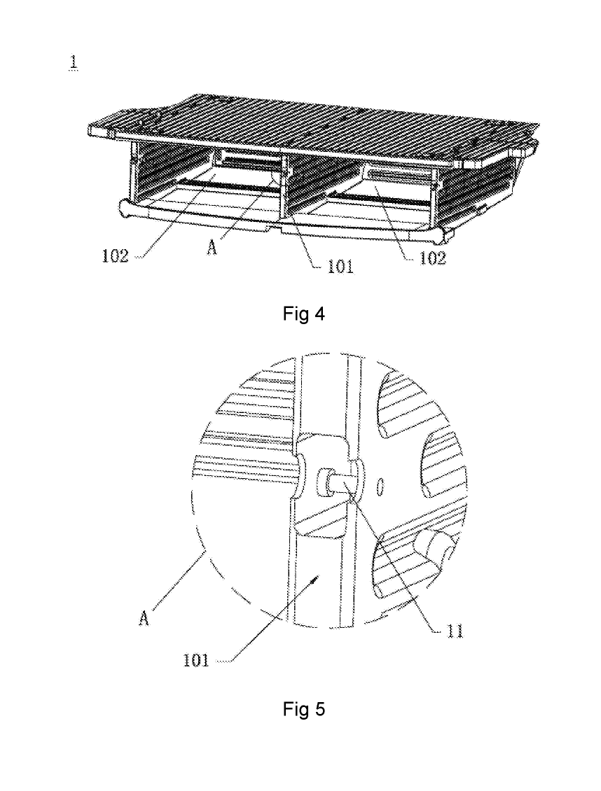

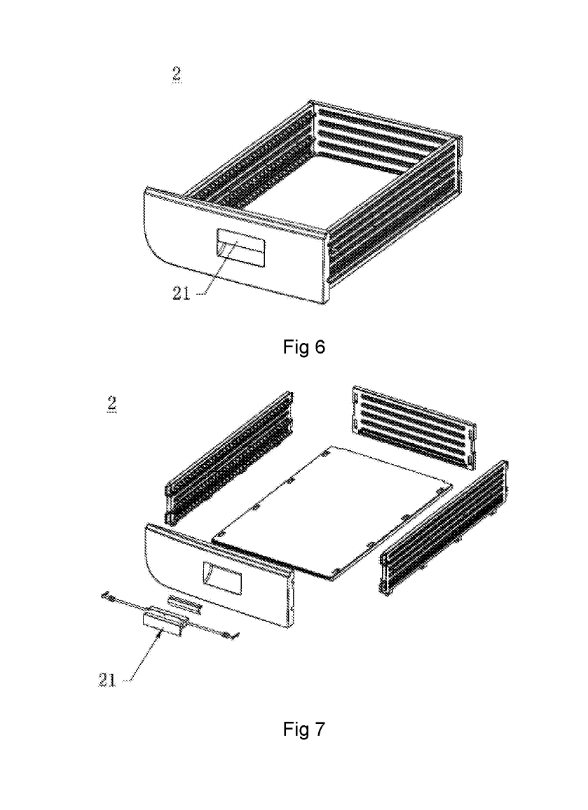

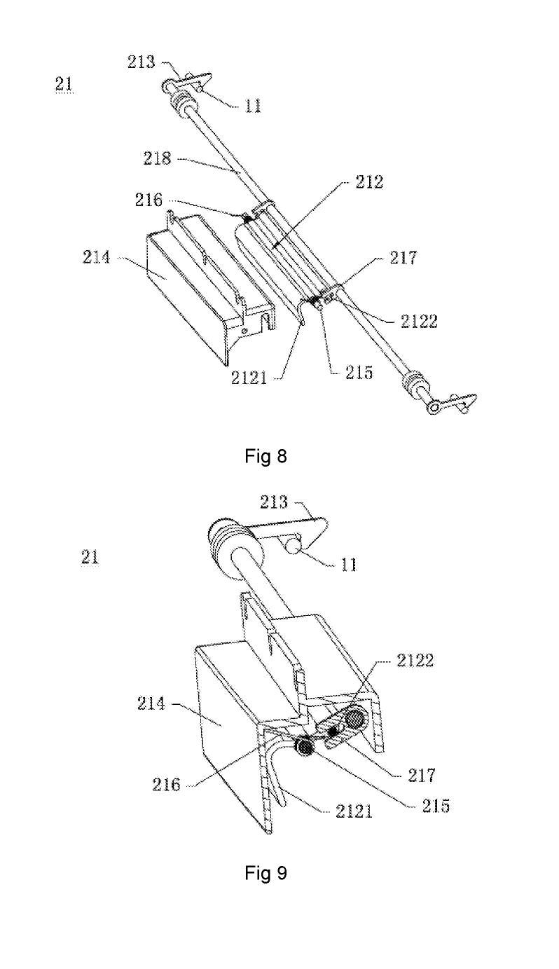

An embodiment of the invention is shown in FIG. 1-FIG. 9. A vehicle-mounted storage box 100 comprises boxes 1; the boxes 1 are provided with push-pull drawers 2; both sides of the drawer 2 are provided with a sliding mechanism 22 that is used to slide the drawer 2; the mechanism 22 comprises guide pulley seats 221, guide pulleys 222, and a guide track 223; the guide pulleys 222 are installed on the guide pulley seats 221, and are rotatable; the guide track 223 is located at one side of the drawer 2; the guide pulley seats 221 are fixed in the box 1 at the positions corresponding to the location of the guide track 223; the guide pulleys 222 are embedded in the guide track 223 and can roll on the guide track 223; there is a ringed groove 2221 carved at the outer edge of the guide pulley 222, and there are raised lines 2231 on the guide track 223, which can be set in the ringed groove 2221; the shape of the ringed groove 2221 is well matched with that of the raised line 2231.

In this embodiment, the cross sections of both the ringed groove 2221 and raised line 2231 are half-round. the structural design of the half-round raised line 2231 at the contact area between the guide track 223 and guide pulleys 222, as well as the overall structural design realize tight joint between the guide pulleys 222 and guide track 223, and no deformation of the guide track 223 when bearing loads, and thus ensure the drawer 2 would slide freely even when carrying high load and produce no excessive clearance. The mechanism can also prevent external impurities from entering the storage box, bring high dust, sand, water, and weather resistance, and keep the guide track 223 unblocked. The guide pulleys 222 used in this embodiment are customized and consistent with the standards of export to Germany. The maximum load capacity of a guide pulley is 30 kg, and each drawer is provided with 10-12 guide pulleys 222. So, the drawer 2 can bear a load of 300 kg without causing any deformation to the guide track 223. The mechanism ensures the drawer 2 would slide freely even when carrying high load and there wouldn't be any abnormal sounds or noise during operation. By contrast, balls and slide track structures used in other vehicle-mounted storage boxes in the market cannot achieve the above effect, and what's more, the slide track would be slack or even blocked with the accumulation of dust.

The said vehicle-mounted storage box 100 further includes the side plates 13 at the sides of the drawer 2; the guide pulley seat 221 includes two symmetrically arranged installation parts 2211, which are respectively fixed on both sides of the side plate 13 and division plate 101; the side plate 13 at the position corresponding to the said installation parts 2211 is well matched with the installation parts 2211 in shape, guaranteeing the installation accuracy and service strength of the guide track 223 bearing & sliding system.

Further, the drawer 2 is provided with a locking device 21; the boxes 1 are provided with fixed blocks 11; the locking device 21 comprises a rotary drive part 212 and a hook 213 that can be driven by the said rotary drive part 212; when the drawer is closed, the hook 213 and fixed block 211 would be buckled.

The said boxes 1 are provided with push-pull drawers 2, so that users can pick and store articles without having to remove the articles on the boxes 1 and lift its top covers 12, and thus save a lot of time and labor. Meanwhile, the drawer 2 is provided with a locking device 21, and users can rotate the rotary drive part 212 of the locking device 21 to lock or open the drawer 2 and thus prevent the drawer 2 from sliding out of the vehicle-mounted storage box 100 due to car body vibration.

Specifically, the said locking device 21 further includes a shield 214, a hinge pin 215, two helical torsion springs 216, drive blocks 217, and a drive link 218 that can be driven by the rotary drive part 212; the shield 214 is placed above the rotary drive part 212 and used to cover the part; the hinge pin 215 is placed through the rotary drive part 212, with its two ends out of the rotary drive part 212; the helical torsion springs 216 are placed at both the ends of the hinge pin 215 by putting them through the hinge pin 215, with the two ends of each spring extending in two opposite directions normal to the hinge pin 215, one end pressing against the bottom surface of the shield 214, and the other end buckling against the bottom surface of the rotary drive part 212; the drive link 218 is placed through the shield 214 and is rotatable; the rotary drive part 212 includes a clasp part 2121 and a drive part 2122 that protrudes from the side of the rotary drive part 212; one end of the drive block 217 is placed on the drive part 2122 by putting it through the drive part, and the other end is fixed on the drive link 218; the hook 213 is fixed on the drive link 218. The vehicle-mounted storage box 100 further includes a division plate 101; the fixed block 11 is fixed on the division plate 101, which divides the inner space of the boxes 1 into at least two storage spaces 102; every one of the storage spaces 102 is provided with a drawer 2.

Once pulling the clasp part 2121, one end of the helical torsion spring 216 would be pressed down, and the drive part 2122 would turn downwards with the hinge pin 215 as the axis and drive the drive block 217, drive link 218, and the hook 213 to rotate anticlockwise. Then, the hook 213 would escape from the fixed block 11, and you can pull the rotary drive part 212 to pull out the drawer 2. Once releasing the rotary drive part 212, the helical torsion spring 216 would return to normal, and its elastic force would make the drive part 2122 turn upwards with the hinge pin 215 as the axis and then drive the drive block 217, drive link 218, and the hook 213 to rotate clockwise. Then the hook 213 would catch the fixed block 11 and the drawer 2 would be locked tightly. Thus, the mechanism can prevent the drawer 2 from sliding out of the vehicle-mounted storage box 100 due to car body vibration. By contrast, existing vehicle-mounted storage boxes are not provided with the locking device and their covers are prone to getting off the boxes duo to car body vibration for the covers are simply nested on the boxes.

The above content is only the description of a preferred embodiment of the invention, and not intended to restrict the scope of the invention. Any modifications, equivalent replacements, and improvements made in accordance with principles and meaning of the invention shall be included in the protection scope of this patent.

What is claimed is:

1. A vehicle-mounted storage box comprising: boxes, wherein the said boxes are provided with push-pull drawers; both sides of the said drawer are provided with a sliding mechanism that is used to slide the said drawer; the said mechanism comprises guide pulley seats, guide pulleys, and a guide track; the said guide pulleys are installed on the guide pulley seats, and are rotatable; the said guide track is located at one side of the drawer; the said guide pulley seats are fixed in the said box at the positions corresponding to the location of the said guide track; the said guide pulleys are embedded in the said guide track and can roll on the said guide track; there is a ringed groove carved at the outer edge of the said guide pulley, and there are raised lines on the said guide track, which can be set in the said ringed groove; the shape of the said ringed groove is well matched with that of the said raised line.

2. The vehicle-mounted storage box according to claim 1, wherein the cross sections of both the said ringed groove and raised line are half-round.

3. The vehicle-mounted storage box according to claim 1, wherein the said vehicle-mounted storage box further includes the side plates at the sides of the said drawer; the said guide pulley seat includes two symmetrically arranged installation parts, which are respectively fixed on both sides of the said side plate; the side plate at the position corresponding to the said installation parts is well matched with the installation parts in shape.

4. The vehicle-mounted storage box according to claim 3, wherein the said vehicle-mounted storage box further includes a division plate, which divides the inner space of the storage box into at least two storage spaces; every one of the storage spaces is provided with a said drawer; both sides of the said division plate are provided with the said installation parts.

5. The vehicle-mounted storage box according to claim 1, wherein the said drawer is provided with a locking device; the said boxes are provided with fixed blocks; the said locking device comprises a rotary drive part and a hook that can be driven by the said rotary drive part; when the said drawer is closed, the said hook and fixed block would be buckled.

6. The vehicle-mounted storage box according to claim 5, wherein the said locking device further includes a shield, a hinge pin, two helical torsion springs, and a drive link that can be driven by the said rotary drive part; the said shield is placed above the said rotary drive part and used to cover the part; the said hinge pin is placed through the said rotary drive part, with its two ends out of the said rotary drive part; the said helical torsion springs are placed at both the ends of the said hinge pin by putting them through the hinge pin, with the two ends of each spring extending in two opposite directions normal to the said hinge pin, one end pressing against the bottom surface of the said shield, and the other end buckling against the bottom surface of the said rotary drive part; the said drive link is placed through the said shield and is rotatable, and then installed on the said rotary drive part; the said the said hook is fixed on the said drive link.

7. The vehicle-mounted storage box according to claim 5, wherein the said rotary drive part includes a clasp part and a drive part that protrudes from the side of the said rotary drive part; the said locking device further includes drive blocks; one end of the said drive block is placed on the said drive part by putting it through the drive part, and the other end is fixed on the said drive link.

8. The vehicle-mounted storage box according to claim 5, wherein the said vehicle-mounted storage box further includes a division plate, which divides the inner space of the storage box into at least two storage spaces; every one of the storage spaces is provided with a said drawer.

9. The vehicle-mounted storage box according to claim 8, wherein the said fixed block is fixed on the said division plate.
